(19) United States
(12) Patent Application Publication
(10) Pub. No.: US 2017/0272453 A1
(43) Pub. Date: Sep. 21, 2017

(54) USER INTERFACE FOR DISPLAYING NETWORK ANALYTICS

(71) Applicant: DataVisor Inc., Mountain View, CA (US)

(72) Inventors: Patrick Glenn Murray, Mountain View, CA (US); Shuo Shan, San Jose, CA (US); Zhong Wu, San Jose, CA (US); Yinglian Xie, Cupertino, CA (US); Hui Xue, San Jose, CA (US); Fang Yu, Sunnyvale, CA (US)

(73) Assignee: DataVisor Inc., Mountain View, CA (US)

(21) Appl. No.: 15/459,664

(22) Filed: Mar. 15, 2017

Related U.S. Application Data
(60) Provisional application No. 62/308,674, filed on Mar. 15, 2016.

(51) Int. Cl. H04L 29/06

(52) U.S. Cl. CPC H04L 63/1416; H04L 67/10

(57) ABSTRACT

Methods, systems, and apparatus, including computer programs encoded on computer storage media, for presenting data to visualize and interact with results of a user analytics engine. One of the systems include one or more computers including one or more processors and one or more memory devices, the one or more computers configured to: identify fraudulent user accounts through analysis of obtained client data; and provide a campaign user interface that plots groups of fraudulent user accounts to visualize them as attack campaigns, rather than displaying by listing individual fraudulent user accounts.

### CROSS-REFERENCE TO RELATED APPLICATIONS

This application claims the benefit under 35 U.S.C. §119(e) of the filing date of U.S. Provisional Patent Application 62/308,674, filed on Mar. 15, 2016, and which is incorporated here by reference.

### BACKGROUND

Network security relies on an ability to detect malicious user accounts. Malicious user accounts can be used to conduct malicious activities, for example, spamming, phishing, fake likes, and fraudulent transactions. Conventional solutions focus on detections of individual bad accounts in a network without focusing on the relationships between accounts.

### SUMMARY

In general, one innovative aspect of the subject matter described in this specification can be embodied in systems that include one or more computers including one or more processors and one or more memory devices, the one or more computers configured to: identify fraudulent user accounts through analysis of obtained client data; and provide a campaign user interface that plots groups of fraudulent user accounts to visualize them as attack campaigns, rather than displaying by listing individual fraudulent user accounts.

The foregoing and other embodiments can each optionally include one or more of the following features, alone or in combination. In particular, one embodiment includes all the following features in combination. An attack campaign corresponds to a group of fraudulent user accounts that are correlated or similar in profile or behavior indicating that the user accounts are likely controlled by the same attackers. The groups of fraudulent user accounts are presented in the user interface according to a plurality of thumbnails, each summarizing a different attack campaign user interface (UI) that summarizes different attack campaigns using thumbnails. A given thumbnail illustrates major actions of a particular attack campaign over time through visualizations of the color and shape of the thumbnail. A timeline of the attack campaign is visible through the thumbnail. A scale of the attack campaign is visible through the thumbnail. A description of the attack campaign associated with each thumbnail is generated automatically using the analyzed client data. The user interface display of thumbnails can be sorted for display according to different criteria. The user interface presents details of a particular selected attack campaign, wherein the details illustrate factors in determining that the group of user accounts are fraudulent. The details provide a summary indicating reasons why the group of user accounts were determined to be fraudulent including an indication of how the set of user accounts are similar or correlated to each other. Highly distinguishing features and their corresponding statistics of the set of fraudulent accounts are automatically displayed and compared to normal user accounts. The user interface provides a geo view pane in response to a user selection associated with a particular attack campaign, and wherein the geo view pane plots an origin of the attack campaign in a world map and shows how the attack campaign evolved using animations within the geo view pane. The user interface provides a campaign linkage view pane in response to a user selection associated with a particular attack campaign, and wherein the campaign linkage view pane shows illustrates correlation between different users in the attack campaign. The linkage view pane provides a graph including a plurality of nodes, each node representing either one fraudulent user account or a set of user accounts. A user selection of a user account in the linkage view pane provides an illustration of correlation of the selected user account with other fraudulent user account. A dynamic view of fraudulent user account correlations over a time period are provided in response to a user input. The campaign linkage view pane provides a representation of a subset of fraudulent user accounts.

In general, one innovative aspect of the subject matter described in this specification can be embodied in methods that include the actions of identifying fraudulent user accounts through analysis of obtained client data; and providing a campaign user interface that plots groups of fraudulent user accounts to visualize them as attack campaigns, rather than displaying by listing individual fraudulent user accounts. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

In general, one innovative aspect of the subject matter described in this specification can be embodied in methods that include the actions of receiving a request from a client user to view a malicious campaign dashboard; providing the malicious campaign dashboard for presentation on a client user device, the malicious campaign dashboard proving a view of a plurality of attack campaigns and their corresponding categories; receiving a user input selecting a particular attack campaign; in response to the selection of the particular attack campaign, providing details about the attack campaign; and in response to a user input selecting a particular view pane, providing a corresponding visualization of the attack campaign details. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Visualizations of attack campaigns allow users to view information about groups of related malicious accounts in an efficient manner. Grouping malicious accounts allows for visualizing attack campaigns in a way that shows an entire attack landscape of an online service in an organized way. A malicious campaign dashboard displays bad users in groups indicating particular attack campaigns and visualizes the commonality and correlations between these users instead of merely displaying bad users one by one. As a result, the campaign dashboard can show how the attacks evolve over time, the origin of the attacks, the attack techniques, and the characteristics of the attack campaign. In addition, campaigns are also auto categorized by criteria such as the attack events, attack time, or attack size. Therefore, the campaign dashboard allows users to find interesting/relevant attack campaigns to review and mediate quickly.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system using a user analytics engine.

FIGS. 2A-B illustrate example dashboard user interfaces.

FIG. 3 shows an example user interface illustrating user interaction with a drop down menu.

FIG. 4 shows an example details interface of a dashboard user interface.

FIG. 5 shows an example summary description interface.

FIG. 6 shows an example set of output features in the stats view pane.

FIG. 7 shows an example user interface of a geo view pane.

FIG. 8 shows an example user interface illustrating connections between different geographic regions for detected accounts.

FIG. 9 shows an example user interface of an early warning view pane.

FIG. 10 shows an example user interface of a linkage view graph pane.

FIG. 11 shows a portion of the linkage view graph of FIG. 10, in which a particular link between nodes is selected.

FIG. 12 is a flow diagram illustrating a client user interface interaction.

Like reference numbers and designations in the various drawings indicate like elements.

### DETAILED DESCRIPTION

This specification describes user interfaces for presenting data to visualize and interact with results of a user analytics engine. A user analytics engine detects fraudulent user accounts and fraudulent activities by grouping them into attack campaigns. An attack campaign refers to a group of fraudulent user accounts exhibiting similar or strongly correlated activities, which indicates that they are likely operated by the same attackers. A campaign of accounts can be used to conduct different illicit activities such as spamming, phishing, fake likes, and fraudulent transactions. Analyzing relationships between user accounts and activities is distinct from traditional approaches that focus on individual accounts.

The user interfaces provided by this specification, for example, a malicious campaign dashboard, provides a way to display detection results to users by visualizing attack campaigns to show the entire attack landscape of an online service in an organized way. The malicious campaign dashboard displays bad users in groups indicating particular attack campaigns and visualizes the commonality and correlations between these users instead of merely displaying bad users one by one.

### Detecting Malicious User Accounts

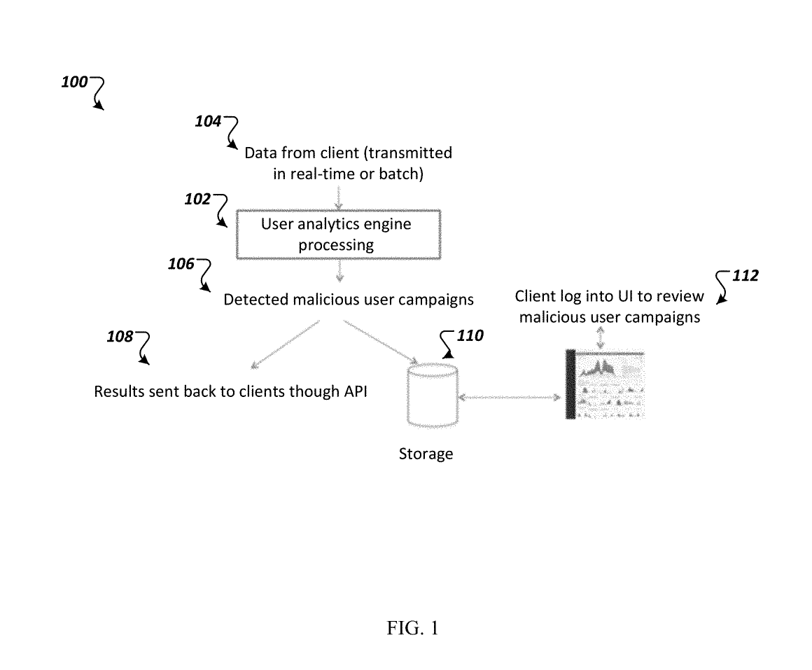

In some implementations, a user analytics engine detects fraudulent user accounts either in batch computation or through real-time analysis. The engine organizes the detected user accounts into attack campaigns and writes results to both the storage systems and to client servers. FIG. 1 illustrates an example system 100 using a user analytics engine 102. Data is obtained from a client 104, e.g., a company or other entity. The data can be obtained in real-time or in batches. The user analytics engine 102 processes the obtained data.

Malicious user campaigns 106 detected by the user analytics engine can be sent back to the client 108, e.g., using an API and/or stored 110. The client can access the stored information 112, for example, by logging into an application or network location providing a UI representation of the malicious user campaign(s). For example, when a client logs into a user interface provided by the system, the system's frontend code fetches campaign results from the storage systems and displays them.

Techniques for detecting attack campaigns are described in greater detail in U.S. patent application Ser. No. 14/620,028 filed on Feb. 11, 2015, Ser. No. 14/620,048 filed on Feb. 11, 2015, Ser. No. 14/620,062 filed on Feb. 11, 2015, and Ser. No. 14/620,029 filed on Feb. 11, 2015, which are each incorporated here by reference.

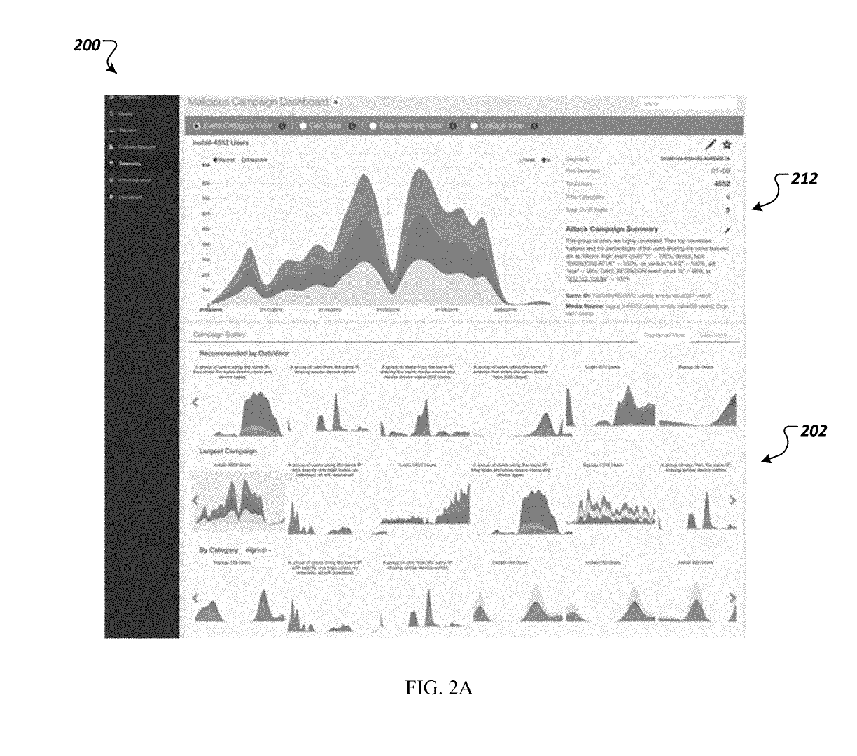

FIGS. 2A-B show an example malicious campaign dashboard. Specifically, FIG. 2A shows a malicious campaign dashboard 200 and FIG. 2B shows a thumbnail portion 210 of the malicious campaign dashboard 200. The malicious campaign dashboard 200 plots one or more detected attack campaigns organized in multiple different ways. Each attack campaign is visualized using a thumbnail 202 in the dashboard display. For each thumbnail 202, the dashboard 200 shows the activities of a group of users over time. Different visual identifiers can be used, for example, to indicate different event types, for example, using color, shading, or other visual indicia. In some implementations, each color denotes a specific event type. For example, the red color may represent registration events conducted by detected user accounts, the blue color may represent login events, and the grey color may represent transaction events. The X-axis of the thumbnail shows the time, and the Y-axis shows the number of total events from the attack campaign at the corresponding timestamp.

When a client logs into the user interface, just by looking at the color distribution of thumbnail views over time, they can get a global view of the event categories and trends from the corresponding fraudulent accounts in a campaign. Note that the color mappings to the event types can be automatically generated, but can also be manually adjusted later. The mapping can be consistent across different attack campaigns for the same client.

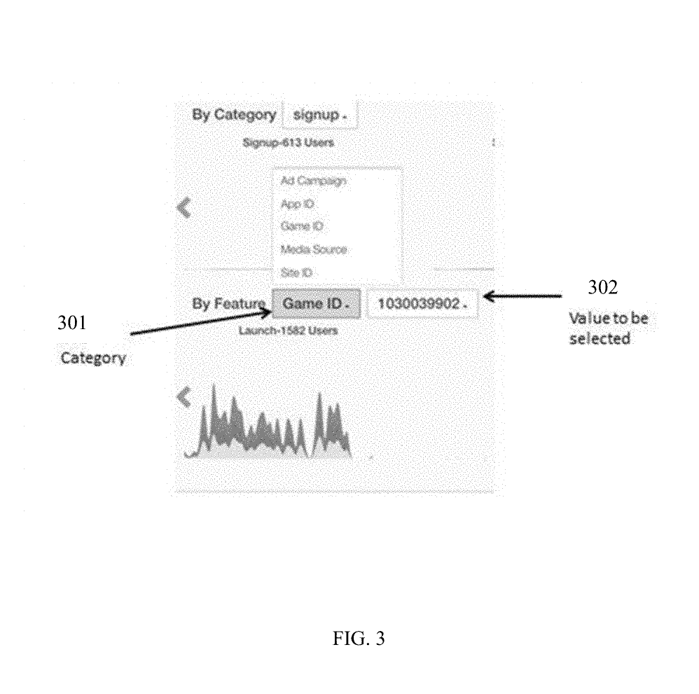

The user analytics engine assigns a title 203 to each attack campaign automatically by default, and the title is shown above the corresponding thumbnail. The title could be a machine generated campaign identifier, or it could be the main category and the size of the campaign. Customers or teams affiliated with the system may also edit (see, e.g., 406 of FIG. 4 below) each title into a description that is more meaningful or easy to remember. The edited title 201 can be stored in the backend storage systems, so next time when a client logs in again, the newly edited title would be pulled and displayed. The titles can be edited again and again overtime.

Customers or teams affiliated with the system can also mark a campaign thumbnail (see e.g., 407 of FIG. 4 below) with a “like” or similar selection. All liked campaign thumbnails can be placed at the top of the dashboard 200, in the section named, in this example, “Recommended by DataVisor”. As shown in FIG. 2B, “liked” campaigns would stay in the top row of the “Recommended by DataVisor” section, so that they can be easily found later.

The user interface of the dashboard 200 can organize campaigns through different ways. By default, the user interface presents campaigns according to campaign size computed as the number of detected user accounts in a campaign.

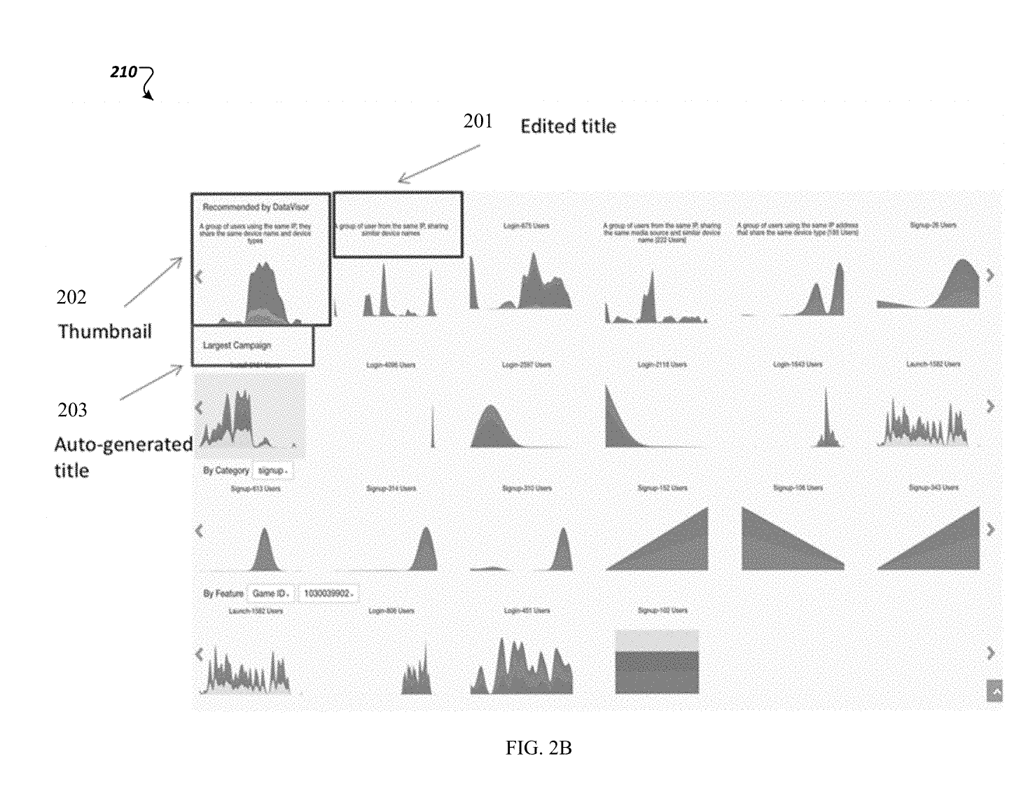

FIG. 3 shows an example user interface 300 illustrating user interaction with a drop down menu 302 associated with the thumbnails 201 shown in FIGS. 2A-B. In particular, the row of thumbnails having a drop down associated with selecting campaigns by feature. Customers can also select campaigns 301 that have specific features, such as having specific event types or with customized features 302. When selecting campaigns according to a feature, the related feature values would be populated in the dropdown box, where the client can further select campaigns based on the desired feature values.

Referring back to FIGS. 2A-2B, when selecting a campaign thumbnail, the dashboard UI displays a details interface 212 that includes details of the campaign features on the top section of campaign dashboard 200. FIG. 4 shows an example of the details interface 212 of FIG. 2A. The details interface 212 includes several panes:

Event category view (401)

Stats view (402)

Geo view (403)

Early warning view (404)

Linkage view (405)

The event category view pane 401 shows the different categories of events conducted by the detected fraudulent accounts from the same attack campaign. This view shows how the campaign evolves over time for their event types. The X-axis represents time and the Y-axis represents the number of events conducted at each timestamp.

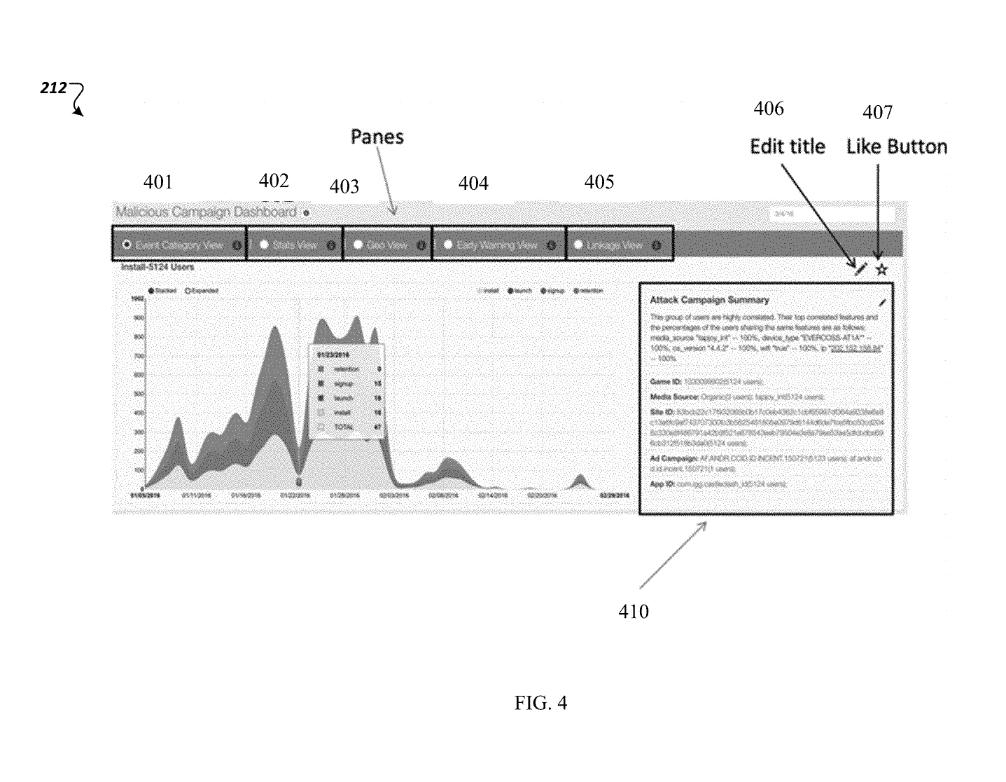

On the right side of the event category view pane 401, a summary description 410 about the corresponding attack campaign is shown (the summary description 410 is illustrated in FIG. 5, below). The summary description 410 provides a succinct summary of why these accounts are detected as bad and grouped together. In the example summary 501, there are 5,124 malicious user accounts in the campaign. These users all come from one media source, using the same type of device, same operating system version, all using WIFI to download games, and all coming from the same IP address. This is highly suspicious as normal user patterns are very diverse. Below the summary 501, detailed event categorizations of the same group of fraudulent user accounts are shown as illustrated by box 502 in FIG. 5.

Referring back to FIG. 4, the stats view pane 402 shows the similarity of the fraudulent accounts from an attack campaign. The stats view pane 402 also compares these accounts from normal account behaviors to show how the malicious accounts behave differently. The user interface can selectively display up to a certain number of feature stats, and order them from the most differentiating features to the least differentiating features.

To select the most differentiating features, for each feature, the system calculates a global difference score. The global difference score has a value of zero at the beginning. The score will be updated by examining a set of value buckets for the corresponding feature. For a feature value bucket where there are more bad users having the feature values falling within the bucket than good users, the system computes the local difference score which is the bad user percentage minus the good user percentage on this feature value bucket. The global difference score is then updated by adding the square of this local difference score. After the system has iterated all feature value buckets using the above procedure, the system takes a square root of the summed global difference score as the final value of the global difference score. All the features are then sorted according to their global difference score in reverse order.

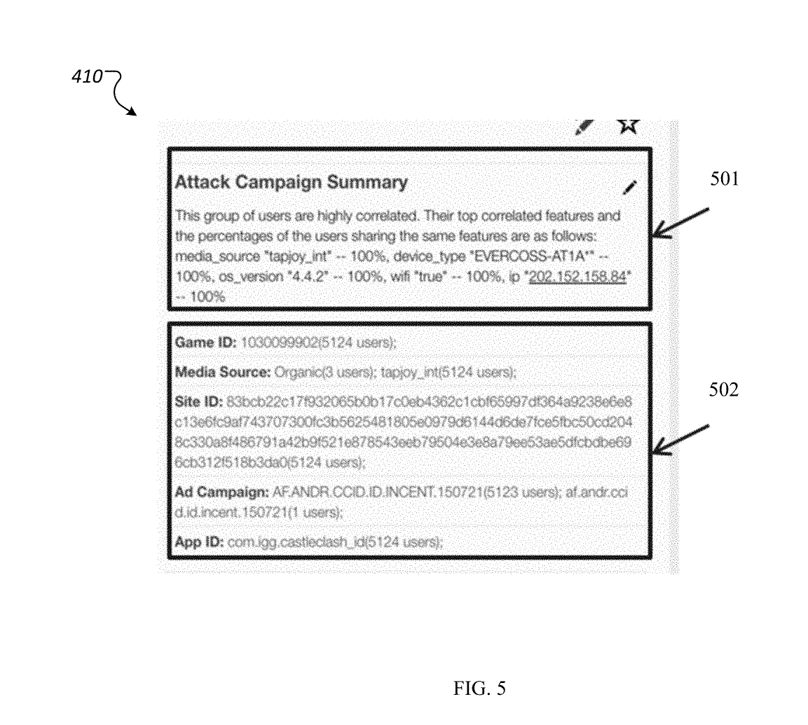

FIG. 6 shows an example set of output features in the stats view pane 600, sorted in order. The stats view pane 600 includes a distribution for a first feature 602, in this example, an app version of the user account, and a distribution 604 for a second feature, in this example an install and signup time difference. The red colored series (601) shows the distribution of fraudulent user accounts captured in this campaign, while the blue colored series (602) shows the distribution of normal user accounts for each of the feature distributions 602 and 604.

By showing these stats distribution comparison figures, clients can easily see the difference of the detected fraudulent users versus normal users. The distributions of the fraudulent users within the same campaign are spikier, as they are controlled by the same attacker and thus often show same or similar feature values. Normal users, on the other hand, have very diverse behaviors in their distributions.

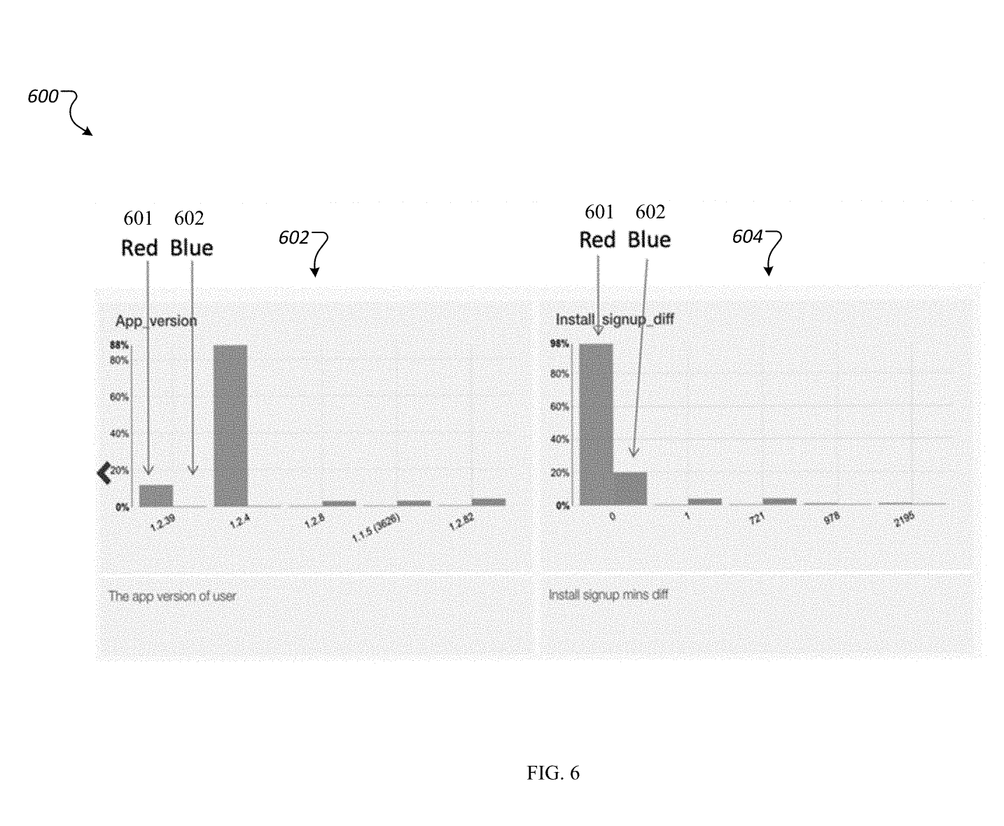

Referring back to FIG. 4, the geo view pane 403 plots the global view of the IP address or GPS sources of the detected users in one campaign. FIG. 7 shows an example user interface of a geo view pane 700. The geo view pane 700 includes a map 702 that indicates areas associated with fraudulent user accounts. Additionally, top geographic regions are listed in a separate panel 704.

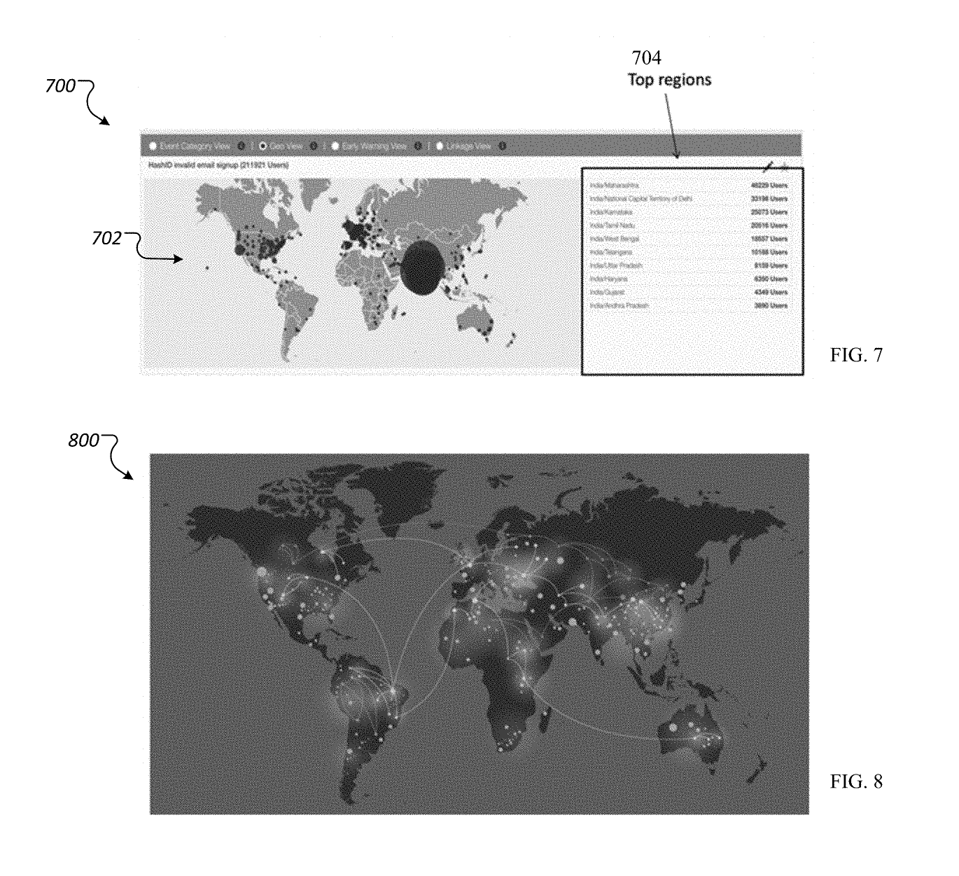

Fraudulent accounts can be very distributed across the geographic regions by using proxy IP addresses, VPN IP addresses, or botnet IP addresses. They could show activities in one country and then move to another country quickly. The UI can replay the sequence of the fraudulent account activities by plotting animated curves connecting different geo regions for the detected accounts. FIG. 8 shows an example user interface 800 illustrating connections between different geographic regions for detected accounts.

Referring back to FIG. 4, the early warning view pane 404 shows how long an attack campaign has incubated before actively launching an attack. Typically, an attack campaign has a combination of incubating events that look more legitimate and benign (e.g. registration, login, viewing profiles) and attacking events that may actually cause damage (e.g. fraudulent transactions, fake reviews).

Since different clients may have different event types, the categorization of incubating vs. attacking events may be client specific. For example, for clients in the financial sector, a transaction event may be defined as an attacking event, while for a social platform, a post or review event may be defined as attacking event. The user analytics engine uses a configuration setting for each client to classify attacking vs. incubating event types for user interface display. This configuration may be set only once when a new client is onboarding with the services provided by the system.

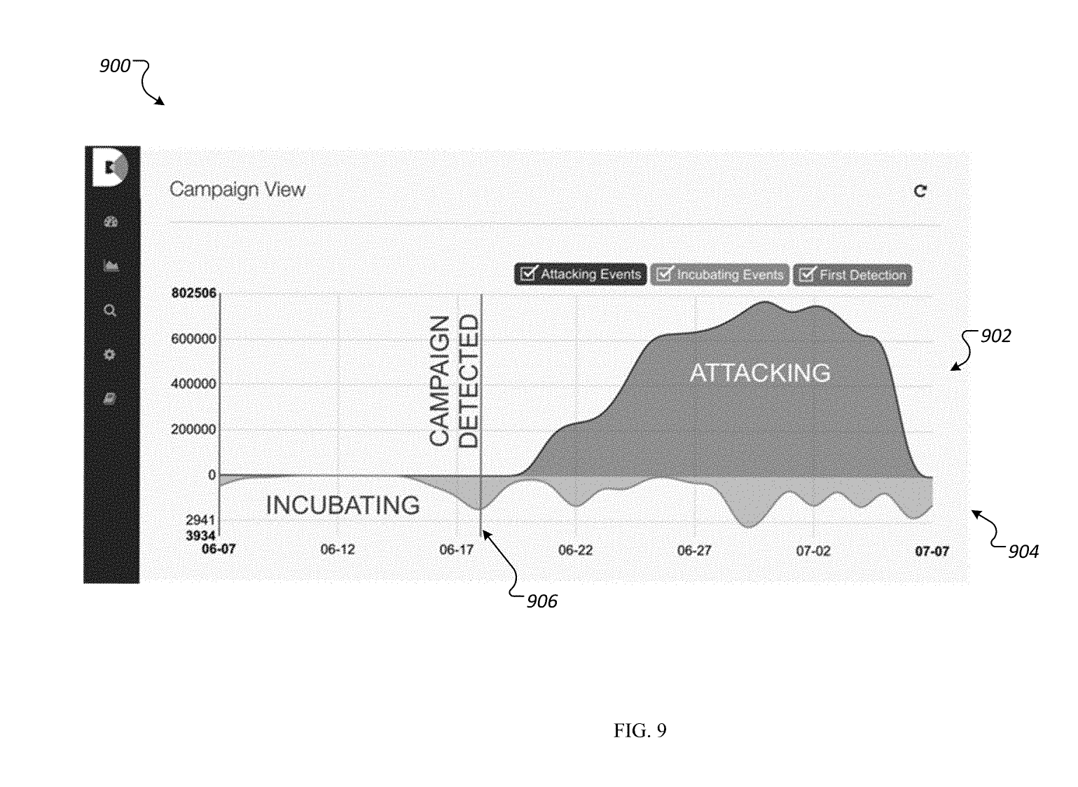

FIG. 9 shows an example user interface of an early warning view pane 900. In the early warning view shown in FIG. 9, the X-axis represents time. The system can plot the attacking event counts 902 on top of the X-axis, while plotting the incubating event counts 904 below the X-axis. In this way, the system can clearly present the period where this attack campaign is incubating only, and observe when the campaign starts to conduct massive attacks. The system may also plot a vertical line 906 to specify the detection date of this attack campaign by the system, showing when the user analytics engine starts to recognize this group of fraudulent users and their attack patterns.

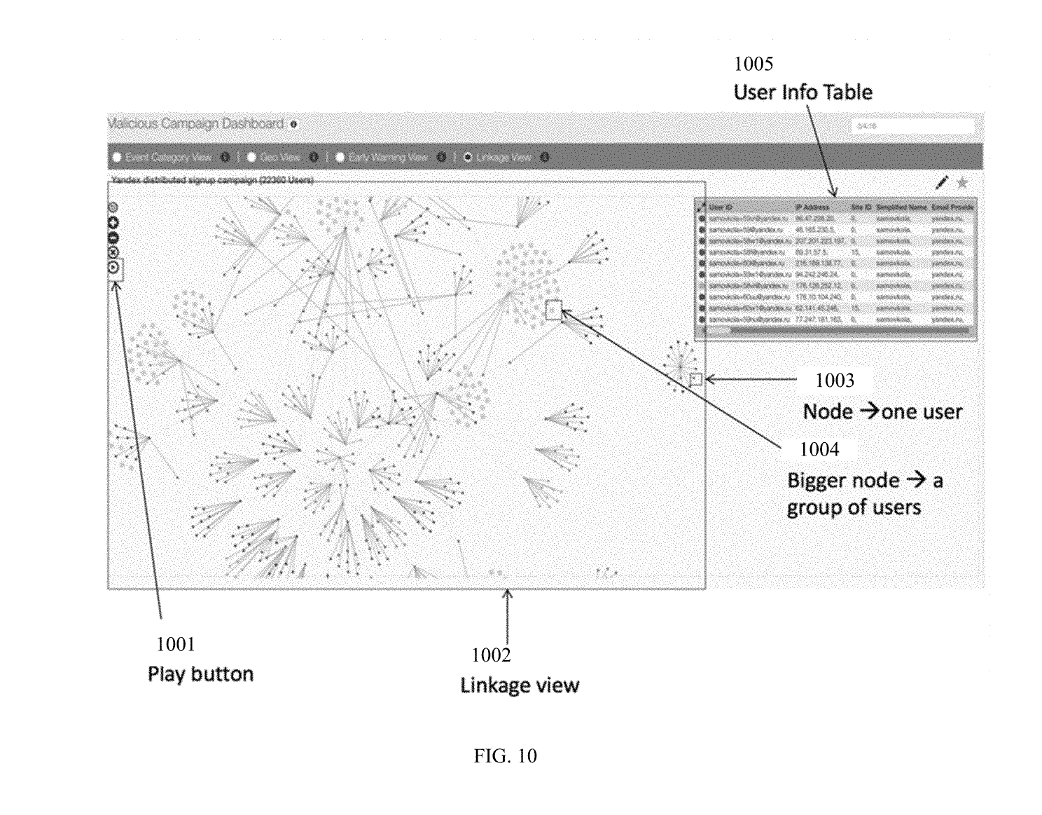

Referring back to FIG. 4, the linkage view 405 shows the detailed similarity and correlations between fraudulent users in one malicious campaign. FIG. 10 shows an example user interface of a linkage view graph pane 1002. As shown in FIG. 10, the linkage view graph 1002 includes nodes of user accounts. Each node in the figure may represent one fraudulent user e.g., node 1003, or a set of fraudulent users, e.g., node 1004, and they are distinguished by the size of the node and color: a larger node represents a user set while a smaller node represents a single fraudulent user.

In some implementations, the system uses the combination of two different types of nodes (one representing single users and the other representing a set of users) because the graph region is often too small in display size to visualize the structure of all single-user nodes clearly. Thus the system may display the graph structure in a two-level hierarchical view, where the linkage between two nodes are generated by the user analytics engine in the backend.

For each node in the linkage view graph 1002, the links to its neighboring nodes mean they are similar or correlated. Two users are linked when they have a subset of features or user attributes in common.

By selecting a fraudulent user node e.g., node 1002 within the graph 1000, the linkage view graph 1002 will expand on demand to draw all other users that are closely correlated with the selected user and link them together, if they have not already been shown in the graph yet.

In some implementations, two bigger nodes representing two user sets may be linked too, if the corresponding groups share a common user. By selecting a bigger node representing a set of fraudulent users, e.g., node 1004, instead of a single user, the corresponding node will be expanded and all the user in that set will be displayed as individual smaller nodes and connected with existing graph.

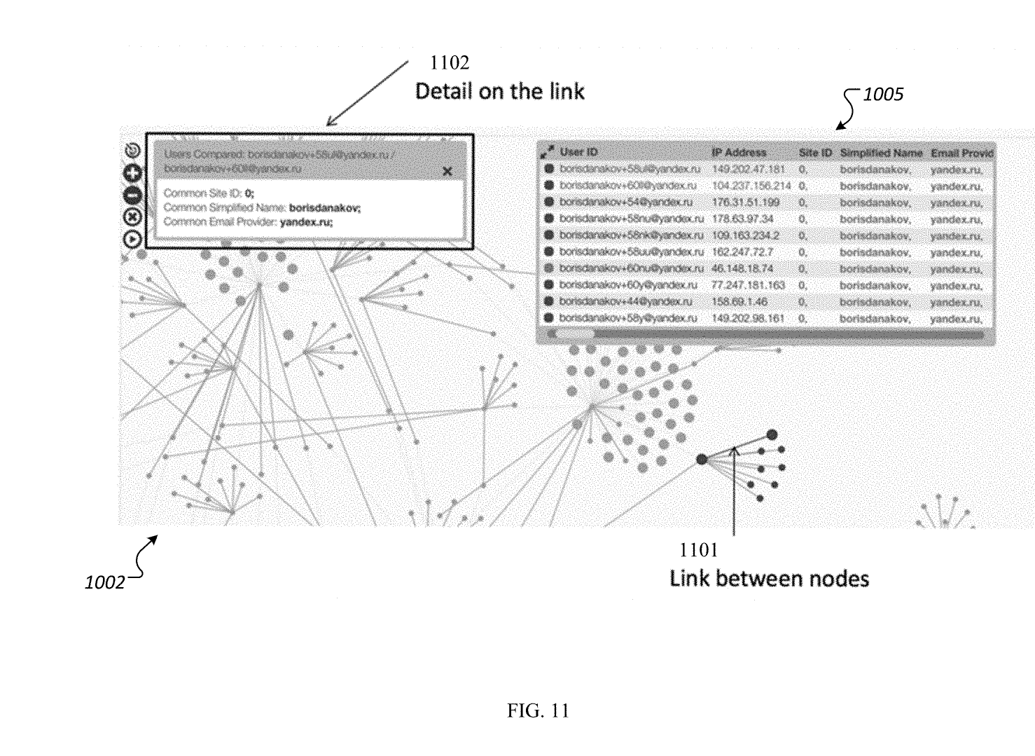

Links between nodes are also selectable in the graph. FIG. 11 shows a portion of the linkage view graph 1002 of FIG. 10, in which a particular link between nodes 1101 is selected. When a client user selects the link 1101 connecting two user nodes, they will see why these two users are similar or correlated. In some implementations, the link will be marked in highlighted color (e.g., red) and the two end nodes of the link and its neighbors will be visually differentiated, e.g., colored, as well. A detailed comparison of the two linked nodes (i.e., users) is displayed on a text panel 1102, which, in the example interface may be a pop up window on demand. Common attributes of the two linked users can be computed and displayed on this text panel 1102.

Referring back to FIG. 10, the entire linkage structure between the detected users in a campaign can be auto displayed with a “play” button 1001, where the linkage view pane shows the entire graph structure at once instead of displaying a user and its neighbors one by one. The play button 1001 can be configured to autoplay the entire campaign time period. When the entire campaign is large, the play button can also be configured to auto display a sampled subset of users or links at once.

A user information table 1005 is shown on the right side of the linkage view graph 1002 for displaying the selected user account details. After selecting a particular user node, the table displays the selected user (on the top row) and all other users that are most similar or correlated with the clicked user. The common attributes for the displayed set of fraudulent users are highlighted (e.g., shown in a different color or in bold text) in the table. The table is user modifiable, e.g., resizable, draggable, and scrollable. When selecting a particular link, the two connected users will be shown on the top two rows of the table and common attributes will also be highlighted (e.g., a different color or shown in bold text). In addition, for all the other users listed in the table, if they share common features or attributes to the selected user node, or the selected link, the common features or attributes of these user rows will be highlighted in display as well to show why all these users are similar or correlated to different degrees.

For very large attack campaigns with many users, in addition to using a hierarchical way of displaying the campaign linkage structure, the UI may sample a subset of users to show in the display panel instead. The sampling algorithm will try to preserve the graph structure by selecting a subset of users across the different components in the linkage graph, and only sampled users will be shown or displayed in the graph as well as in the user information table.

### Malicious Campaign Dashboard UI Flow

The malicious campaign dashboard is part of the user analytics system as shown in FIG. 1. The system takes user activity data from the client service either through API feed or through batch log upload. Then the system processes the data in batch or in real time to detect fraudulent user campaigns. The detected fraudulent users, together with their campaign information are sent back to the client service through API. In addition, these information data are also stored in storage systems such as SQL databases, cloud storage systems (e.g., AWS S3), index and search systems (e.g., Elastic Search), no SQL systems (e.g., Hbase), and traditional file systems. The malicious campaign dashboard frontend code reads the information from the storage systems and display it to corresponding client devices.

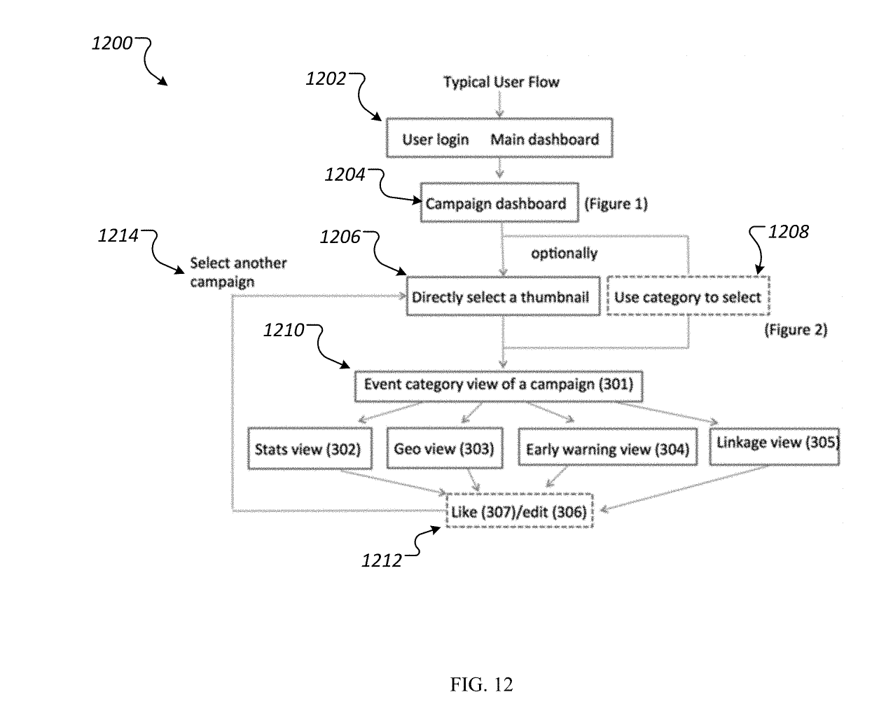

FIG. 12 is a flow diagram illustrating a client user interface interaction. A client typically goes through the following steps to interact with the UI. After logging in, the client navigates to the malicious campaign dashboard (1202) to see a global overview of the attack campaigns and their corresponding categories. If a client is interested in examining a specific campaign illustrated in the campaign dashboard (1204), they select the corresponding thumbnail (1206). Alternatively, the user can select a particular attack campaign by category (1208). The client then visualizes the campaign details by selecting a view pane (e.g., geo view pane) (1210) to obtain further details about a particular attack campaign. During this process, the client may mark the campaign with a “like” or edit the title (1212). The client may then move on to a different attack campaign to view (1214).

In this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

In this specification, the term “database” is used broadly to refer to any collection of data: the data does not need to be structured in any particular way, or structured at all, and it can be stored on storage devices in one or more locations.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or electronic system that may include one or more processing devices and memory to store executable instructions to perform the operations described in this specification.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. An system comprising:
one or more computers including one or more processors and one or more memory devices, the one or more computers configured to:
identify fraudulent user accounts through analysis of obtained client data; and
provide a campaign user interface that plots groups of fraudulent user accounts to visualize them as attack campaigns, rather than displaying by listing individual fraudulent user accounts.

2. The system of claim 1, wherein an attack campaign corresponds to a group of fraudulent user accounts that are correlated or similar in profile or behavior indicating that the user accounts are likely controlled by the same attackers.

3. The system of claim 1, wherein the groups of fraudulent user accounts are presented in the user interface according to a plurality of thumbnails, each summarizing a different attack campaign user interface that summarizes different attack campaigns using thumbnails.

4. The system of claim 3, wherein a given thumbnail illustrates major actions of a particular attack campaign over time through visualizations of the color and shape of the thumbnail.

5. The system of claim 3, wherein a timeline of the attack campaign is visible through the thumbnail.

6. The system of claim 3, wherein a scale of the attack campaign is visible through the thumbnail.

7. The system of claim 3, wherein a description of the attack campaign associated with each thumbnail is generated automatically using the analyzed client data.

8. The system of claim 3, wherein the user interface display of thumbnails can be sorted for display according to different criteria.

9. The system of claim 1, wherein the user interface presents details of a particular selected attack campaign, wherein the details illustrate factors in determining that the group of user accounts are fraudulent.

10. The system of claim 9, wherein the details provide a summary indicating reasons why the group of user accounts were determined to be fraudulent including an indication of how the set of user accounts are similar or correlated to each other.

11. The system of claim 9, wherein highly distinguishing features and their corresponding statistics of the set of fraudulent accounts are automatically displayed and compared to normal user accounts.

12. The system of claim 1, wherein the user interface provides a geo view pane in response to a user selection associated with a particular attack campaign, and wherein the geo view pane plots an origin of the attack campaign in a world map and shows how the attack campaign evolved using animations within the geo view pane.

13. The system of claim 1, wherein the user interface provides a campaign linkage view pane in response to a user selection associated with a particular attack campaign, and wherein the campaign linkage view pane shows illustrates correlation between different users in the attack campaign.

14. The system of claim 13, wherein the linkage view pane provides a graph including a plurality of nodes, each node representing either one fraudulent user account or a set of user accounts.

15. The system of claim 13, wherein a user selection of a user account in the linkage view pane provides an illustration of correlation of the selected user account with other fraudulent user account.

16. The system of claim 13, wherein a dynamic view of fraudulent user account correlations over a time period are provided in response to a user input.

17. The system of claim 13, wherein the campaign linkage view pane provides a representation of a subset of fraudulent user accounts.

18. A method comprising:
identifying fraudulent user accounts through analysis of obtained client data; and
providing a campaign user interface that plots groups of fraudulent user accounts to visualize them as attack campaigns, rather than displaying by listing individual fraudulent user accounts.

19. A method comprising:
receiving a request from a client user to view a malicious campaign dashboard;
providing the malicious campaign dashboard for presentation on a client user device, the malicious campaign dashboard proving a view of a plurality of attack campaigns and their corresponding categories;
receiving a user input selecting a particular attack campaign;
in response to the selection of the particular attack campaign, providing details about the attack campaign; and
in response to a user input selecting a particular view pane, providing a corresponding visualization of the attack campaign details.
